(19) United States
(12) Patent Application Publication
(10) Pub. No.: US 2009/0323339 A1
(43) Pub. Date: Dec. 31, 2009

(54) POSITIONABLE LIGHTING ASSEMBLIES

(75) Inventors: Joseph John Janos, Wadsworth, OH (US); John Joseph Ascherl, Medina, OH (US)

Correspondence Address: CALFEE HALTER & GRISWOLD, LLP, 800 SUPERIOR AVENUE, SUITE 1400, CLEVELAND, OH, 44114, US

(73) Assignee: The L.D. Kichler Co., Cleveland, OH (US)

(21) Appl. No.: 12/478,432

(22) Filed: Jun. 4, 2009

Related U.S. Application Data
(60) Provisional application No. 61/058,749, filed on Jun. 4, 2008.

(51) Int. Cl. F21V 17/06; F21V 11/00

(52) U.S. Cl. 362/249.1; 362/368

(57) ABSTRACT

A lighting assembly includes a housing, a light source at least partially disposed in the housing, a mounting stem including a joint portion secured to the housing, a fastening member axially fixed to and rotatable with respect to the mounting stem, and a mounting member configured to affix to an external surface. The mounting member includes an attachment portion configured to selectively attach to the fastening member. When the fastening member is attached to the attachment portion of the mounting member, the fastening member is tightened against the mounting stem to secure the mounting stem in a desired rotational position with respect to the mounting member.

### CROSS REFERENCE TO RELATED APPLICATION

This application claims priority to, and any other benefit of, U.S. Provisional Patent Application Ser. No. 61/058,749, entitled POSITIONABLE LIGHTING ASSEMBLIES and filed Jun. 4, 2008, the entire disclosure of which is fully incorporated herein by reference.

### BACKGROUND

Lighting products, such as for example, outdoor lighting products, are often used as accent lights, floodlights, spotlights, or other such lighting arrangement in which a light source is positioned in a specific desired orientation, to direct illumination in a specific desired direction. In one embodiment, an outdoor accent light is mounted to a ground surface by a mounting stake that is shaped to be easily embedded in the ground. When a lighting product is preassembled to a mounting stake prior to installation of the stake in the ground, the lighting product may be susceptible to damage as the stake is pounded into the ground. Other conventional lighting products include a threaded base that may be assembled with a threaded mounting stake after the stake has been embedded in the ground. However, threading the lighting product with the embedded mounting stake can result in twisting or kinking of the electrical wire by which the lighting product is connected with an external power source.

### SUMMARY

The present application contemplates assemblies and accessories for selectively positioning mounted devices, such as, for example, lighting products, to be secured in a desired orientation. Accordingly, in one embodiment, a lighting assembly includes a housing, a light source at least partially disposed in the housing, a mounting stem including a joint portion secured to the housing, a fastening member axially fixed to and rotatable with respect to the mounting stem, and a mounting member configured to affix to an external surface. The mounting member includes an attachment portion configured to selectively attach to the fastening member. When the fastening member is attached to the attachment portion of the mounting member, the fastening member is tightened against the mounting stem to secure the mounting stem in a desired rotational position with respect to the mounting member.

The present application further contemplates methods for selectively positioning mounted devices, such as, for example, lighting products, to be secured in a desired orientation. Accordingly, one such method utilizes a lighting assembly having a housing, a light source at least partially disposed in the housing, a mounting stem secured to the housing, a mounting nut axially fixed to and rotatable about the mounting stem, and a mounting member configured to affix to an external surface. The mounting member is secured to an external surface. A male threaded portion of the mounting nut is loosely assembled with a female threaded portion of the mounting member. The mounting stem is rotated with respect to the mounting member to a desired rotational orientation. The male threaded portion of the mounting nut is tightened with the female threaded portion of the mounting member such that the male threaded portion constricts against the mounting stem, thereby securing the mounting stem in the desired rotational orientation.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention, wherein:

FIG. 1A is a cross-sectional side schematic view of an exemplary positionable lighting assembly, shown in an adjustable condition;

FIG. 1B is a cross-sectional side schematic view of the positionable lighting assembly of FIG. 1A, shown in a secured condition;

FIG. 2A is a side cross-sectional view of an exemplary mounting member, mounting stem, and fastening member for a positionable lighting assembly;

FIG. 2B is an exploded perspective view of the mounting member, mounting stem, and fastening member of FIG. 2A;

FIG. 3A is a cross-sectional view of an exemplary positionable lighting assembly;

FIG. 3B is a front perspective view of the positionable lighting assembly of FIG. 3A;

FIG. 3C is a rear perspective view of the positionable lighting assembly of FIG. 3A;

FIG. 3D is a front perspective view of the positionable lighting assembly of FIG. 3A, with the light source and a portion of the housing removed to illustrate additional features of the lighting assembly;

FIG. 3E is a lower perspective view of the body member of the positionable lighting assembly of FIG. 3A; and

FIG. 4 illustrates a method of mounting a lighting assembly to an external surface to direct light in a desired orientation.

### DETAILED DESCRIPTION

The present invention is directed toward positionable lighting fixtures and portables (“lighting products”). Exemplary embodiments include, for example lighting fixtures and portables having light emitting diode (LED) light sources, and mountable lighting products having rotatable and/or pivotable arrangements for adjusting the position or direction of a light source.

As contemplated in the present application, lighting products may be positioned or mounted in a variety of ways for selectively orienting light sources (and their illumination) in a desired direction, for example, for use as landscaping lights, such as detail or accent lights to highlight various landscaping features. To facilitate positionability, a lighting product may be provided with one or more mounting members, such as a flange for mounting with fasteners to a wall or similar structure, or a stake for embedding in the ground. The mounting member may be connected with a housing in which the light source is at least partially disposed or carried. The use of such a mounting member may provide for more permanent fixation of the lighting product, as well as improved placement or direction of the emitted light. In one embodiment, a positionable outdoor lighting product may include a housing connected to a mounting member by an adjustable joint or connection, such that the mounted lighting product may be positioned or adjusted to direct emitted light in a desired direction, such as towards a landscaping feature (e.g., fountains or foliage).

According to an inventive aspect of the present application, a mountable lighting assembly may include a housing that is attachable to, and positionable with respect to, a mounting member after the mounting member has been secured to an external surface, such as a wall or an outdoor ground surface. This lighting assembly may be configured such that, once the lighting product has been rotated to a desired rotational orientation with respect to the mounting member, no additional rotation of the lighting product is required for attachment of the lighting product to the mounting member, allowing the lighting product to be secured in the desired rotational orientation. While many different configurations may be utilized to provide for this rotational adjustability and attachment, in one embodiment, a lighting product may include a mounting stem secured to a housing and a fastening member axially fixed to, and rotatable with respect to, the mounting stem. The fastening member may be configured to be attached to a mounting member, and may be further configured to tighten against or grippingly engage the mounting stem upon attachment with the mounting member, thereby securing the rotational orientation of the mounting stem (and housing and light source).

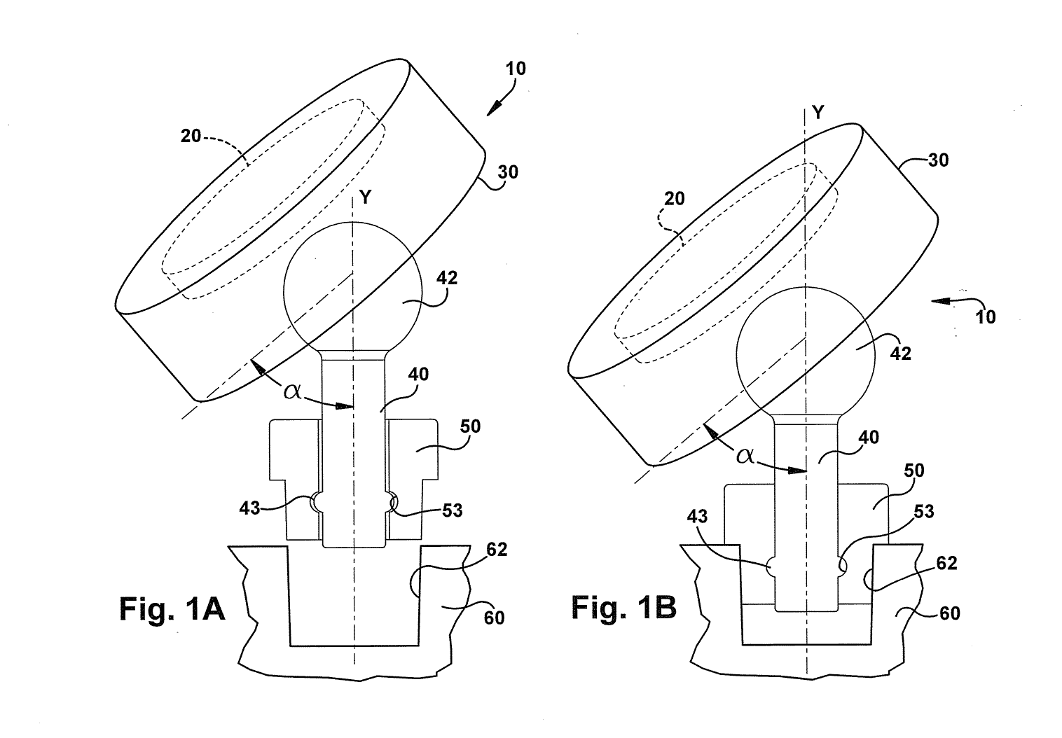

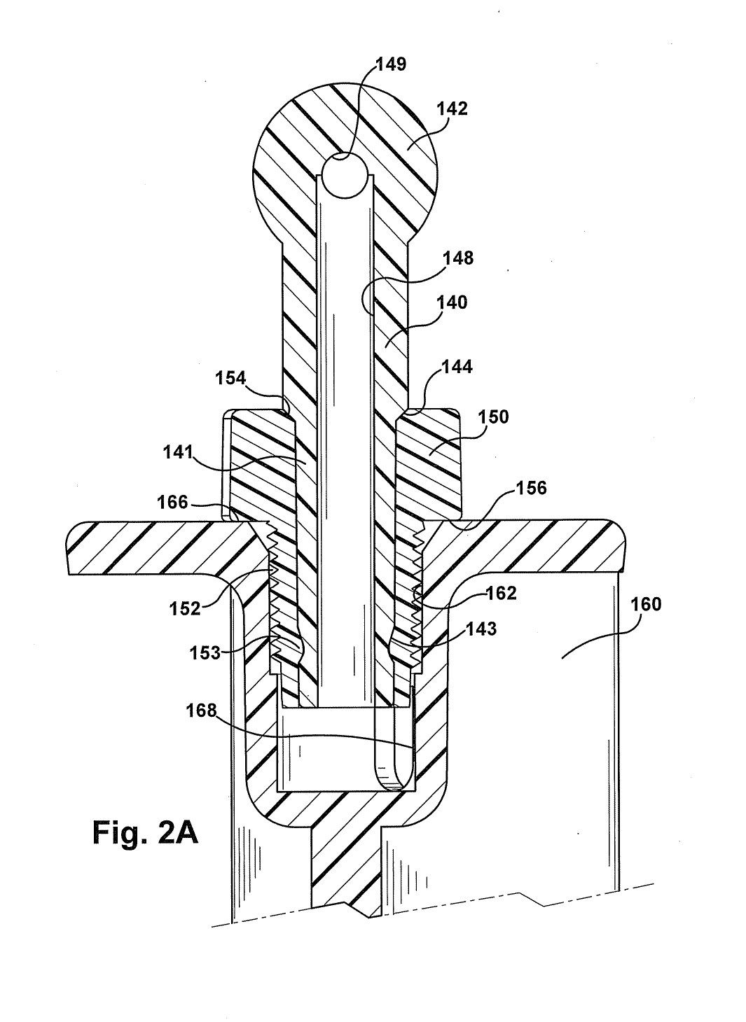

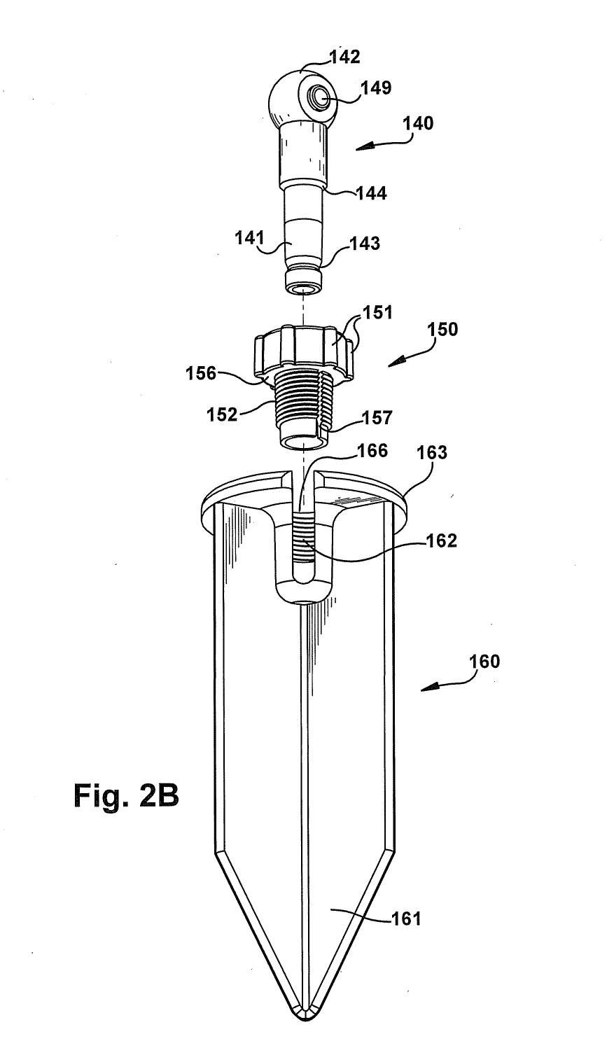

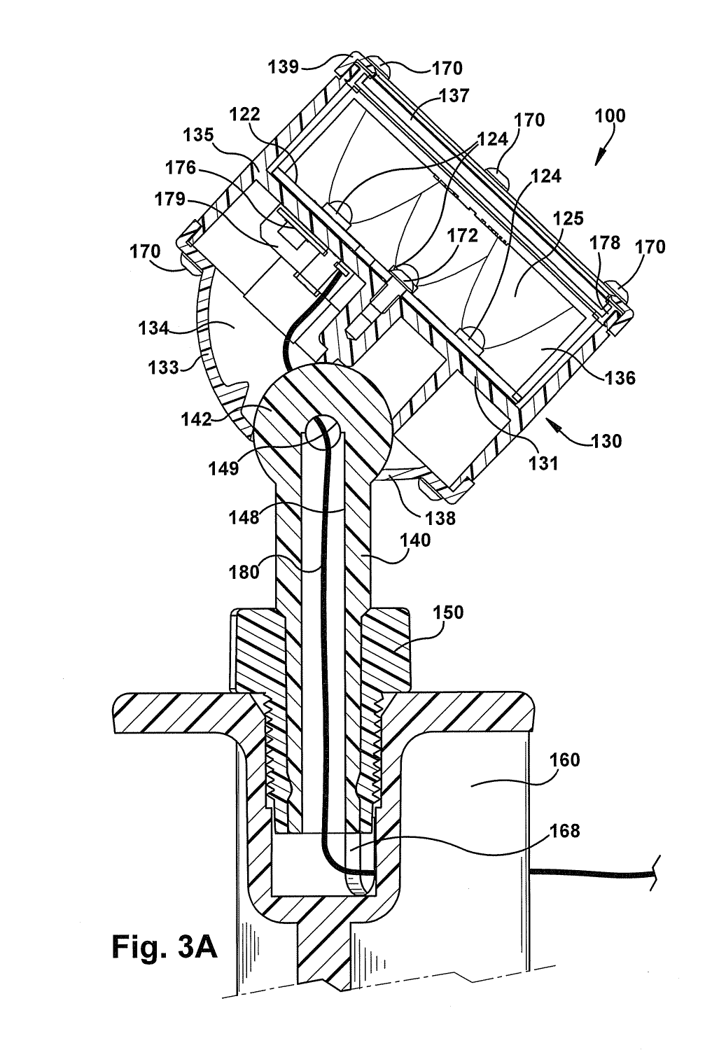

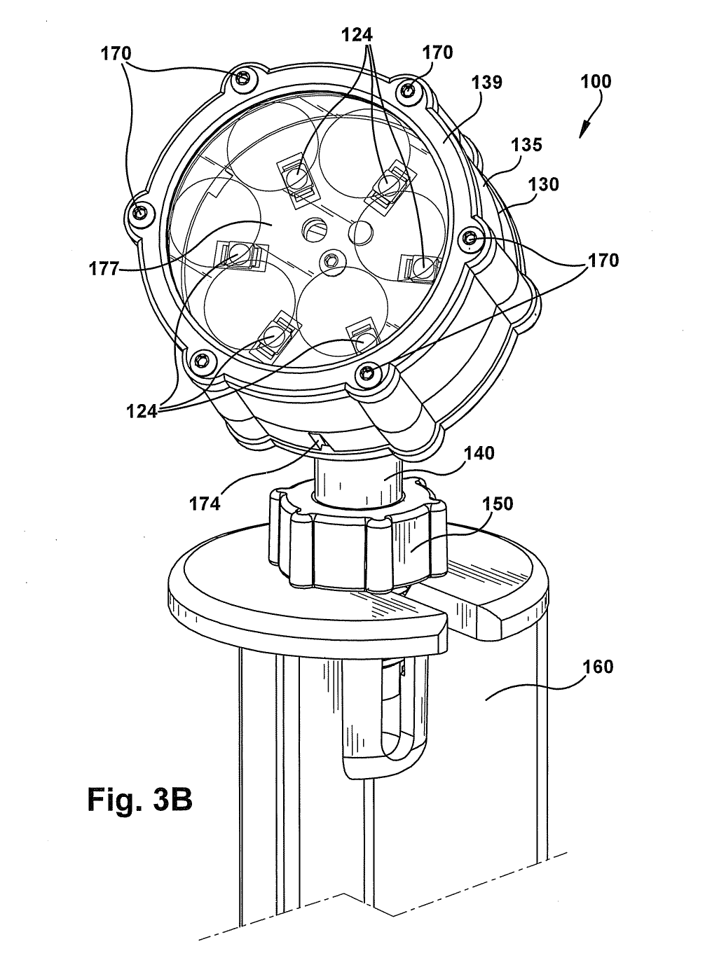

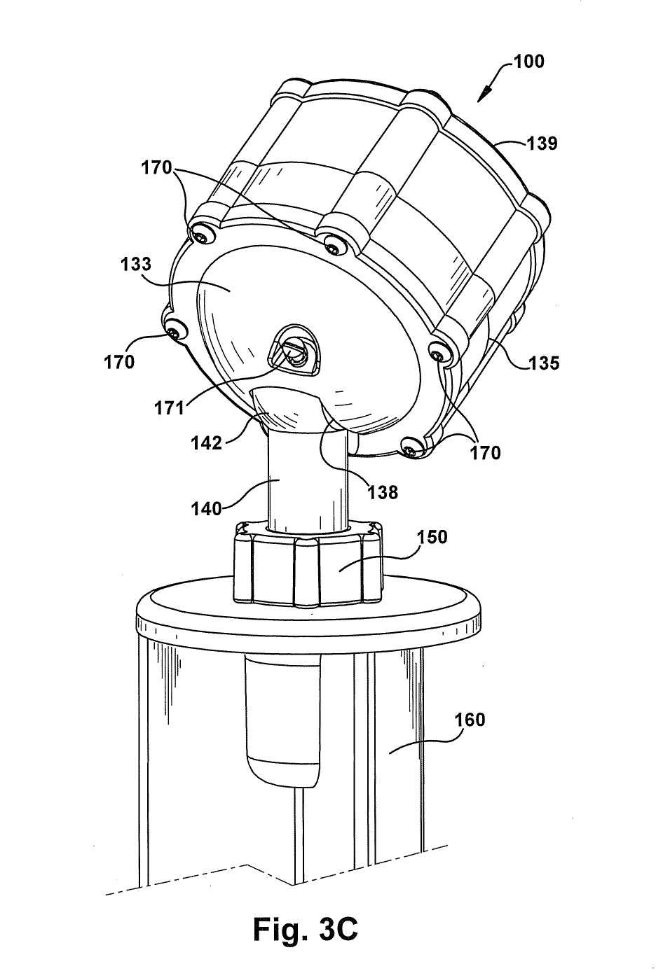

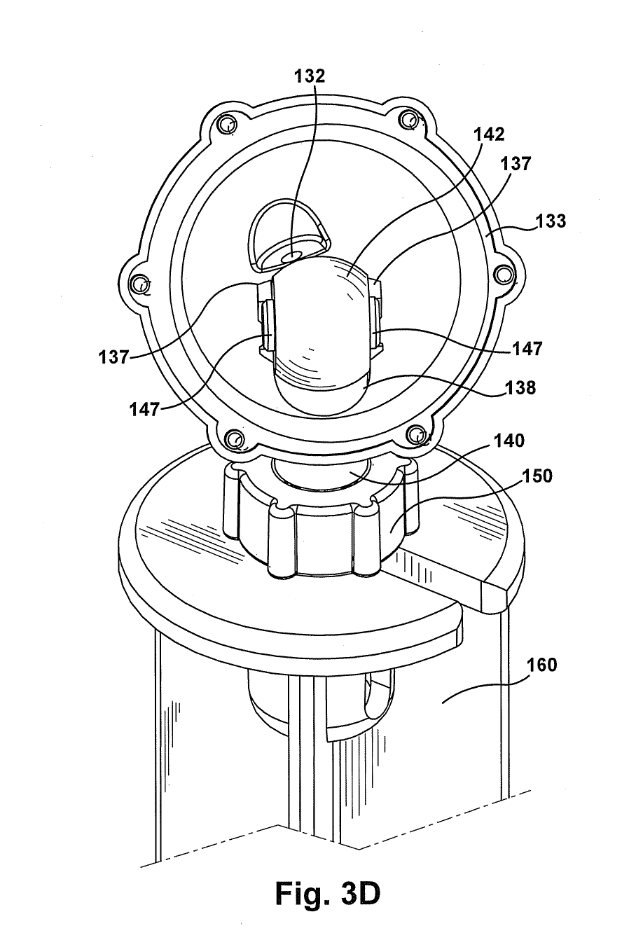

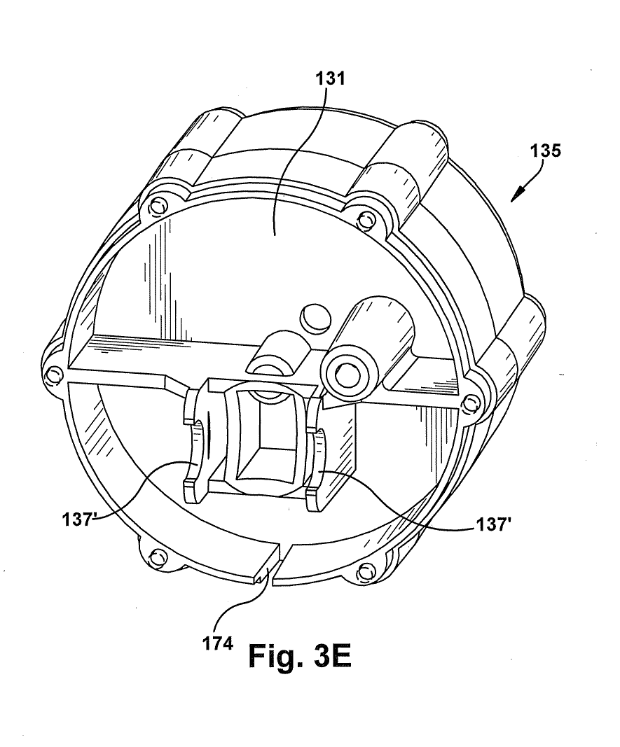

FIGS. 1A and 1B schematically illustrate an exemplary embodiment of a lighting assembly 10 having a light source 20 carried by a housing 30. A mounting stem 40 is secured to the housing 30 at a first end or joint portion 42 of the mounting stem 40. A fastening member 50 is axially fixed to, and rotatable with respect to, the mounting stem 40. While many different arrangements may be used to provide for this axially fixed, rotatable engagement, in the illustrated embodiment, the fastening member 50 includes an inner circumferential groove 53, and the mounting stem 40 includes one or more complementary shaped outer projections 43 that slide within the groove 53 to allow for rotation of the fastening member 50 with respect to the mounting stem 40. In another embodiment (such as, for example, the embodiment of FIGS. 2A-3D), the mounting stem may be provided with an outer circumferential groove, and the fastening member may be provided with one or more corresponding inner projections. Other arrangements may provide this axially fixed rotatable engagement, such as, for example, ball bearing engagement between the mounting stem and fastening member, or crimped or collared assembly of the two components.

As shown, the fastening member 50 may be assembled with an attachment portion 62 of a mounting member 60 (for example, a mounting flange or ground stake) to secure the lighting assembly 10 to an external surface (e.g., ground or wall surface, not shown). As shown in FIG. 1A, when the fastening member 50 is partially or loosely assembled with the attachment portion 62 of the mounting member 60, the mounting stem 40 is loose within the fastening member 50 to permit rotation of the mounting stem 40 with respect to the fastening member 50. When the fastening member 50 is fully assembled or attached with the attachment portion 62 of the mounting member 60 (as shown in FIG. 1B), the fastening member 50 tightens, compresses, or constricts against the mounting stem 40 to prevent further rotation of the mounting stem 40 with respect to the fastening member 50 (and mounting member 60). While the fastening member 50 is shown as surrounding the mounting stem 40, in another embodiment (not shown), the mounting stem may include a hollow portion that receives a fastening member for axially fixed rotation of the fastening member within the mounting stem. In such an arrangement, the fastening member may expand upon attachment with the mounting member, to tighten the fastening member against the mounting stem to prevent further rotation.

As shown in FIGS. 1A and 1B, the housing 30 and light source 20 may be disposed at an angle α with respect to a central axis Y of the mounting stem 40. While the housing 30 and light source 20 may be permanently fixed as this angle, in another embodiment (described in greater detail below), the lighting assembly 10 may be configured such that the housing 30 is selectively pivotable about the joint portion 42 of the mounting stem 40 to adjust the housing 30 (and light source 20) to a desired angular orientation. A locking mechanism (also described in greater detail below) may (i.e., may, but need not) be used to secure the housing in this desired angular orientation.

Many different types of arrangements may be used to tighten or attach the fastening member 50 to the mounting member 60, including, for example, threaded, twist-lock, or push-to-connect connections. FIGS. 2A and 2B illustrate exemplary embodiments of a mounting stem 140, fastening member (or mounting nut) 150, and mounting member 160, utilizing threaded engagement between the fastening member 150 and mounting member. The mounting stem 140 includes a joint portion 142 at a first end, and a necked down portion 141 having an circumferential groove 143 sized to receive a corresponding inner circumferential rib 153 of the fastening member 150. The mounting stem 140 may be press fit or staked into the fastening member 150 for an axially fixed, rotatable engagement between the mounting stem 140 and fastening member 150. Complementary shaped shoulders 144, 154 may be provided on the mounting stem 140 and fastening member 150 for a positive stop during assembly and upon alignment of the rib 153 with the groove 143. The fastening member 150 includes a male threaded portion 152 configured to threadably engage a corresponding female threaded attachment portion 162 of the mounting member 160 for assembly of the fastening member 150 with the mounting member 160. The fastening member 150 and mounting member 160 may be provided with abutting shoulders 156, 166 for a positive stop during assembly. Further, an outer surface of the fastening member 150 may be contoured (for example, with ribs 151) to provide a gripping surface to facilitate hand tightening or loosening.

The male threaded portion 152 of the fastening member 150 is configured to compress into secure engagement with the mounting stem 140 upon tightening the fastening member 150 with the mounting member 160. To produce this compression, one or both of the male and female threaded portions 152, 162 may be tapered, such that compression of the male threaded portion 152 increases during assembly of the fastening member 150 with the mounting member. In an exemplary embodiment, the female threaded portion 162 of the mounting member 160 is provided with a straight thread, and the male threaded portion 152 of the fastening member 160 is provided with a tapered thread (e.g., a 1.5° taper) of matching pitch (e.g., ½-14 pipe threads). To facilitate compression of the male threaded portion 152, the fastening member 150 may be constructed from a compressible material (for example, polycarbonate or some other plastic material) and may be softer or more compressible than the material used to construct the mounting member 160. Further, one or more axially extending slots 157 may be provided in the male threaded portion 152 (see FIG. 2B) to allow the male threaded portion 152 to “flex” for further compression. This “flexing” may also facilitate assembly of the mounting stem 140 with the fastening member 150, as this flexing allows the fastening member 150 to be pressed onto the mounting stem 140 to receive the rib 153 in the corresponding groove 143.

As shown in FIG. 2B, the exemplary mounting member 160 is a ground stake configured to be embedded in a ground surface, for example, for use with landscape lighting on residential or commercial property. The ground stale 160 includes a spike portion 161 shaped to be easily embedded in a ground surface, and a head portion 163 configured to withstand impact (for example, from a hammer or mallet) when the ground stake 160 is driven into the ground. Other types of mounting members may be used, such as, for example, wall mount brackets or clamps.

To electrically connect a positionable lighting product with an external power source, a mounting arrangement may be provided with a passage or channel through which an electrical wire (connected to the light source) may extend. In the illustrated embodiment of FIGS. 2A and 2B, the mounting stem 140 includes an internal passage 148 that extends from the joint portion 142 to the end of the necked down portion 141. The joint portion 142 includes side channels 149 that intersect the passage 148 for receiving the electrical wire 180 (see FIG. 3A) into the passage 148. The mounting member 160 includes a slot 168 or other such external wiring aperture in communication with the internal passage 148 (e.g., extending through the attachment portion 162) to allow the electrical wire 180 to extend from the mounting member 160 to the external power source (not shown).

The joint portion 142 of the mounting stem 140 may be pivotably secured to a housing of a lighting product, such that the housing (and the light source it carries) may be pivoted to a desired angular orientation with respect to the mounting stem 140. FIGS. 3A and 3D illustrate one such pivotable connection, in which side bearing portions 147 of the mounting stem 140 are retained in, and bear against, corresponding bearing surfaces 137 (FIG. 3D), 137′ (FIG. 3E) of the housing 130. While the housing may be configured to pivot with respect to the mounting stem about more than one axis, in the illustrated embodiment, the housing 130 pivots about an axis defined by the retained bearing portions 147. Further, by centering the side channels 149 on the bearing portions 147, movement of the electrical wire 180 extending through one or both side channels 149 may be minimized, thereby reducing the potential for wear or damage to the wire.

As shown in FIGS. 3A, 3C, and 3D, the mounting stem 140 may extend through a slot 138 in a base member 133 of the housing 130. The size and shape of the slot 138 may be configured to define the limit and extent of pivoting movement of the housing 130 with respect to the mounting stem 140.

To secure the housing 130 in a desired angular orientation with respect to the mounting stem 140, the housing 130 may be “pre-loaded” on the mounting stem 140, such that a grip or interference fit between the housing and the mounting stem causes the housing to resist angular movement unless an intentional user force is applied to the housing 130. While many different pre-loaded or interference fit arrangements may be utilized, in the illustrated example, the bearing surfaces 137, 137′ of the housing are sized and contoured to grippingly receive the corresponding bearing portions 147 of the mounting stem 140.

A locking mechanism may additionally or alternatively be provided with one of the housing and the mounting stem to selectively engage the other of the housing and the mounting stem when the housing has been pivoted to the desired angular orientation. In one embodiment, a locking fastener is assembled with the housing and is adjustable to engage the mounting stem to clamp or grip the mounting stem within the housing. In the illustrated embodiment, as shown in FIG. 3C, a locking screw 131 is assembled with a threaded hole 132 in the base member 133 of the housing 130 (see FIG. 3D), such that when the locking screw 131 is tightened, the end of the locking screw engages an outer surface of the joint portion 142 of the mounting stem 140 to secure the mounting stem 140 in the desired angular orientation.

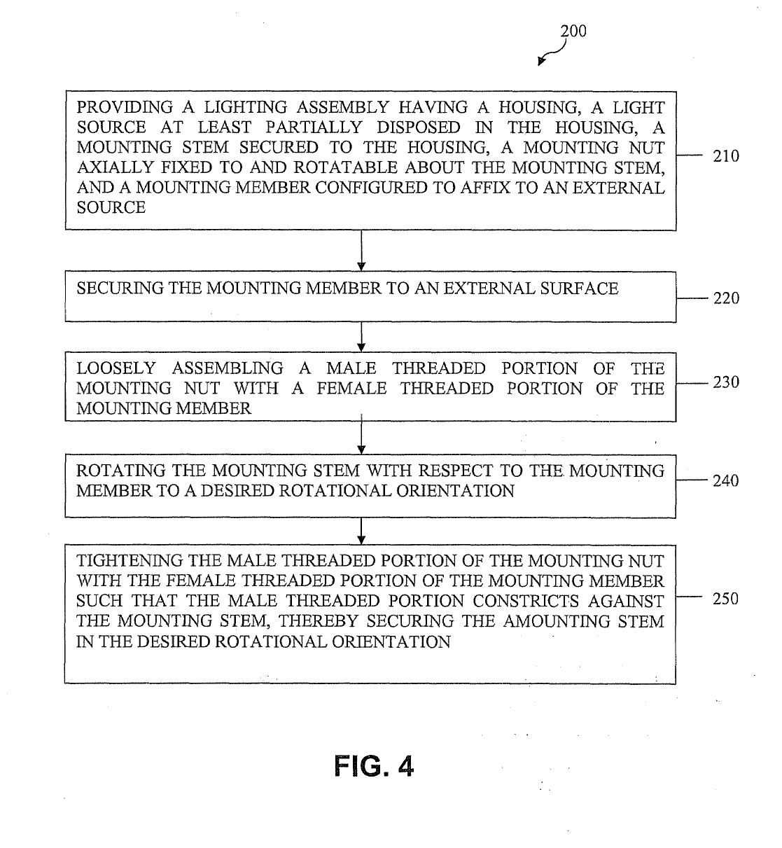

FIG. 4 is a block diagram illustrating an exemplary method 200 for mounting a lighting assembly to an external surface to direct light in a desired orientation. In the exemplary method 200, a lighting assembly is provided with a housing, a light source at least partially disposed in the housing, a mounting stem secured to the housing, a mounting nut axially fixed to and rotatable about the mounting stem, and a mounting member configured to affix to an external surface (block 210). The mounting member is secured to an external surface (block 220). A male threaded portion of the mounting nut is loosely assembled with a female threaded portion of the mounting member (block 230). The mounting stem is rotated with respect to the mounting member to a desired rotational orientation (block 240). The male threaded portion of the mounting nut is tightened with the female threaded portion of the mounting member such that the male threaded portion constricts against the mounting stem, thereby securing the mounting stem in the desired rotational orientation (block 250).

The mounting arrangement described herein (and any one or more of the inventive features thereof) may be utilized with many types of lighting products (including, for example, incandescent, fluorescent, and halogen lighting products), and may also be used with other mountable and positionable devices, such as, for example, speakers and video monitoring equipment. In one embodiment, a positionable lighting assembly may be provided with a light source having one or more light emitting diodes (LED). FIGS. 3A-3D illustrate an exemplary positionable lighting assembly 100 which utilizes a light source including light emitting diodes (LEDs) 124. Other examples of LED lighting products (which may be provided with or configured to include one or more of the inventive features described herein) are described in co-pending U.S. patent application Ser. No. 11/931,052, entitled POSITIONABLE OUTDOOR LIGHTING and filed on Oct. 31, 2007, the entire disclosure of which is incorporated herein by reference.

In the exemplary lighting assembly 100 of FIGS. 3A-3D, the housing 130 includes a base member 133, a body member 135, an outer lens member 177, and an outer flange member 139, secured together by fasteners 170 (though other assembly arrangements may be utilized), as shown in FIG. 3A. The body member 135 and lens member 177 together define a lighting cavity 136, in which the circuit board 122 carrying LEDs 124 is retained. While the exemplary lighting assembly 100 is provided with six LEDs 124, any suitable number may be provided. The circuit board 122 may be assembled to a central wall 131 of the body member 135 (for example, with a fastener 172), and may be thermally coupled to the body member 135, such that the housing (which may be constructed from a thermally conductive material) may function as a heat sink for the LEDs 124. An optical control lens 125 may be included in the lighting cavity 136 to direct and/or focus the light emitted from the LEDs. In the illustrated embodiment, the optical control lens 125 includes parabolic lenses aligned with the LEDs. A lens gasket 178 may be provided between the outer flange member 139 and the lens member 177 to prevent exposure of the LEDs 124 to water.

As shown in FIG. 3A, the body member 135 and base member 133 together define a base cavity 134 to retain the joint portion 142 of the mounting stem 140. An AC-DC converter 176 may be provided in the base cavity 134 in electrical communication with the circuit board 122, to convert an AC source voltage supplied by an external power source to a DC supply voltage for powering the LEDs. In other embodiments (not shown), an AC-DC converter (external driver) may instead be externally connected with the lighting assembly to convert a power supply to DC voltage. A potting member 179 (or other sealant or gasket) may be provided to seal the AC-DC converter 176 against moisture. A slot 174 in the body member 135 (FIG. 3B) may be provided to allow moisture to drain from the base cavity 134, and may also allow heat generated by the LEDs 124 and the AC-DC converter 176 to vent from the housing 130.

Many different suitable materials may be used in constructing the exemplary lighting assembly 100. For example, in one exemplary embodiment, the housing (base member, body member, and outer flange member) is provided in a thermally conductive metal, such as, for example, aluminum or brass. The exemplary optical control lens is provided in a plastic having desired optical properties, such as, for example, optical grade acrylic. The exemplary protective lens member is provided in a glass material, which may be tempered. The exemplary lens gasket is formed from an elastomer, such as, for example, silicone rubber. The exemplary fasteners are provided in a corrosion resistant metal, such as, for example, stainless steel. The exemplary mounting stem and fastening member are provided in a plastic, such as, for example, polycarbonate. The exemplary mounting member (ground stake) is provided in an impact resistant plastic, such as, for example, acrylonitrile butadiene styrene (ABS).

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. For example, the teachings herein, describing exemplary embodiments of lighting including light emitting diodes (LEDs), may be used with many different types of lighting products (fixtures or portables), such as, for example, incandescent, fluorescent, and halogen lighting products. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

What is claimed is:

1. A lighting assembly for mounting to an external surface, the lighting assembly comprising:
a housing;
a light source at least partially disposed in the housing;
a mounting stem including a joint portion secured to the housing;
a fastening member axially fixed to and rotatable with respect to the mounting stem; and
a mounting member configured to be affixed to the external surface, the mounting member including an attachment portion configured to selectively attach to the fastening member; and
wherein when the fastening member is attached to the attachment portion of the mounting member, the fastening member is tightened against the mounting stem to secure the mounting stem in a desired rotational position with respect to the mounting member.

2. The lighting assembly of claim 1, wherein the housing is pivotable about the joint portion of the mounting stem to adjust an angular orientation of the light source with respect to the mounting stem.

3. The lighting assembly of claim 2, further comprising a locking fastener assembled with the housing and configured to be tightened against an outer surface of the joint portion to secure the angular orientation of the light source with respect to the mounting stem.

4. The lighting assembly of claim 1, wherein the joint portion of the mounting stem comprises first and second bearing portions, and the housing comprises first and second bearing surfaces configured to receive the first and second bearing portions for pivoting the housing about an axis defined by the first and second bearing portions.

5. The lighting assembly of claim 4, wherein at least one of the first and second bearing portions includes a channel for receiving an electrical wire connected with the light source.

6. The lighting assembly of claim 4, wherein the first and second bearing portions are pre-loaded against the corresponding first and second bearing surfaces to resist pivoting movement of the housing about the axis defined by the first and second bearing portions.

7. The lighting assembly of claim 1, wherein the mounting member comprises a mounting stake configured to be embedded in a ground surface.

8. The lighting assembly of claim 1, further comprising an electrical wire connected to the light source for providing external power to the light source, the mounting stem comprising an internal passage through which the electrical wire extends.

9. The lighting assembly of claim 8, wherein the mounting member comprises an external wiring aperture through which the electrical wire extends for connecting with an external power source.

10. The lighting assembly of claim 1, wherein one of the mounting stem and the fastening member includes a circumferential groove, and the other of the mounting stem and the fastening member includes a protrusion received in the circumferential groove to axially fix the fastening member to the mounting stem.

11. The lighting assembly of claim 1, wherein the fastening member comprises a male threaded portion at least partially surrounding the mounting stem and the attachment portion of the mounting member comprises a female threaded portion, the male threaded portion being compressible, wherein at least one of the male and female threaded portions is tapered, such that when the fastening member is threaded with the attachment portion, the male threaded portion constricts to secure the mounting stem in the desired rotational position.

12. The lighting assembly of claim 11, wherein the male threaded portion comprises an axially extending slot sized to facilitate compression of the male threaded portion.

13. The lighting assembly of claim 1, wherein the light source comprises at least one LED.

14. The lighting assembly of claim 1, wherein the housing is rotationally fixed with respect to the mounting stem.

15. A method of mounting a lighting assembly to an external surface to direct light in a desired orientation, the lighting assembly having a housing; a light source at least partially disposed in the housing; a mounting stem secured to the housing; a mounting nut axially fixed to and rotatable about the mounting stem; and a mounting member configured to affix to an external surface, the method comprising:
securing the mounting member to an external surface;
loosely assembling a male threaded portion of the mounting nut with a female threaded portion of the mounting member;
rotating the mounting stem with respect to the mounting member to a desired rotational orientation; and
tightening the male threaded portion of the mounting nut with the female threaded portion of the mounting member such that the male threaded portion constricts against the mounting stem, thereby securing the mounting stem in the desired rotational orientation.

16. The method of claim 15, further comprising pivoting the housing with respect to the mounting stem to position the light source in a desired angular orientation.

17. The method of claim 16, wherein pivoting the housing with respect to the mounting stem comprises pivoting the housing about an axis defined by first and second bearing portions of the mounting stem, the first and second bearing portions engaging corresponding first and second bearing surfaces of the housing.

18. The method of claim 15, further comprising extending an electrical wire connected with the light source through a passage in the mounting stem and through an aperture in the mounting member for connection with an external power source.

19. A lighting assembly comprising:
a housing;
a light source at least partially disposed in the housing;
a mounting stem including a joint portion secured to the housing, the housing being rotationally fixed to and pivotable about the joint portion to adjust an angular orientation of the light source with respect to the mounting stem; and
an electrical wire connected to the light source and extending through an internal passage in the mounting stem and through a wiring aperture in the mounting member for connecting with an external power source;
wherein the joint portion of the mounting stem comprises first and second bearing portions, and the housing comprises first and second bearing surfaces configured to receive the first and second bearing portions for pivoting the housing about an axis defined by the first and second bearing portions, the first and second bearing portions being pre-loaded against the corresponding first and second bearing surfaces to resist pivoting movement of the housing about the axis defined by the first and second bearing portions;
further wherein at least one of the first and second bearing portions includes a channel for receiving the electrical wire therethrough.

20. The lighting assembly of claim 19, further comprising a mounting member for affixing the lighting assembly to an external surface, the mounting member being attachable to the mounting stem, wherein the mounting member comprises an external wiring aperture in communication with the internal passage in the mounting stem for receiving the electrical wire therethrough for connecting with an external power source.

21. A lighting assembly for mounting to an external surface, the lighting assembly comprising:
a housing;
a light source at least partially disposed in the housing, the light source comprising at least one LED;
an electrical wire connected to the light source for providing external power to the light source;
a mounting stem including a joint portion rotationally fixed to and pivotable with respect to the housing to adjust an angular orientation of the light source with respect to the mounting stem, the joint portion including first and second bearing portions pre-loaded against corresponding first and second bearing surfaces of the housing to resist pivoting movement of the housing about an axis defined by the first and second bearing portions, wherein at least one of the first and second bearing portions includes a channel for receiving an electrical wire connected with the light source;
a fastening member axially fixed to and rotatable with respect to the mounting stem, the fastening member comprising a male threaded portion at least partially surrounding the mounting stem and including an axially extending slot sized to facilitate compression of the male threaded portion; and
a mounting member configured to be affixed to the external surface, the mounting member including an attachment portion comprising a female threaded portion configured to selectively attach to the male threaded portion of the fastening member, and an internal passage extending to an external aperture through which the electrical wire extends; and
wherein when the fastening member is attached to the attachment portion of the mounting member, the fastening member is tightened against the mounting stem to secure the mounting stem in a desired rotational position with respect to the mounting member;
further wherein one of the mounting stem and the fastening member includes a circumferential groove, and the other of the mounting stem and the fastening member includes a protrusion received in the circumferential groove to axially fix the fastening member to the mounting stem; and
further wherein at least one of the male and female threaded portions is tapered, such that when the fastening member is threaded with the attachment portion, the male threaded portion constricts to secure the mounting stem in the desired rotational position.

22. A method of mounting a lighting assembly to an external surface to direct light in a desired orientation, the lighting assembly having a housing; a light source at least partially disposed in the housing; a mounting stem secured to the housing; a mounting nut axially fixed to and rotatable about the mounting stem; and a mounting member configured to affix to an external surface, the method comprising:
embedding a mounting stake disposed on the mounting member in an external ground surface;
loosely assembling a male threaded portion of the mounting nut with a female threaded portion of the mounting member;
rotating the mounting stem with respect to the mounting member to a desired rotational orientation;
tightening the male threaded portion of the mounting nut with the female threaded portion of the mounting member such that the male threaded portion constricts against the mounting stem, thereby securing the mounting stem in the desired rotational orientation;
pre-loading a bearing portion of the mounting stem against a bearing surface to resist pivoting movement of the housing about an axis defined by the bearing portion;
pivoting the housing about the axis defined by the bearing portion of the mounting stem, the first and second bearing portions engaging corresponding first and second bearing surfaces of the housing;
extending an electrical wire connected with the light source through a passage in the mounting stem and through an aperture in the mounting member for connection with an external power source.
